(19) United States
(12) Patent Application Publication
(10) Pub. No.: US 2012/0224355 A1
(43) Pub. Date: Sep. 6, 2012

(54) LIGHT DIFFUSION SHEET, DISPLAY PANEL, AND DISPLAY DEVICE

(76) Inventor: Yasuyuki Umenaka, Osaka-shi (JP)

(21) Appl. No.: 13/510,788

(22) PCT Filed: Nov. 25, 2010
(86) PCT No.: PCT/JP2010/071043

§ 371 Date: May 18, 2012

(30) Foreign Application Priority Data
Dec. 1, 2009 (JP) 2009-273727

(51) Int. Cl. G02B 5/02; G09F 13/04

(52) U.S. Cl. 362/97.1; 359/599

(57) ABSTRACT

A light diffusion sheet (10) includes wide viewing regions (1) and narrow viewing regions (2). Each of the wide viewing regions (1) includes (i) low refractive parts (22) each having a shape which projects from a light emitting surface toward a light entering surface and (ii) a high refractive part (21) having a refractive index higher than that of the low refractive part (22). Each of the narrow viewing regions (2) includes (a) low refractive parts (24) each having a shape which projects from the light entering surface toward the light emitting surface and (b) a high refractive part (23) having a refractive index higher than that of the low refractive part (24). A display device carries out (i) wide viewing display by incidence of light from a liquid crystal panel (100) side to the wide viewing regions (1) and (ii) narrow viewing display by incidence of light from the liquid crystal panel (100) side to the narrow viewing regions (2), so as to change a viewing angle.

### TECHNICAL FIELD

The present invention relates to a light diffusion sheet, a display device including the light diffusion sheet, and a display device including the display panel.

### BACKGROUND ART

A light diffusion sheet has been conventionally used in a display device so as to obtain a wide viewing angle of the display device, whereby a visibility of an observer is improved. The light diffusion sheet is adhered onto a polarizing plate of the display device. The light diffusion sheet refracts light from the display device in many directions by use of a difference in refractive index, so as to obtain a free viewing angle. Such a light diffusion sheet is described in Patent Literatures 1 and 2. A display device including such a light diffusion sheet always has a wide viewing angle. This allows an improvement in visibility of an observer.

There is, however, a case where it is not preferable from the viewpoint of confidentiality that what is displayed on a display device is viewed in a wide range of visual field. In this case, a display device having a narrow viewing angle is required. Such a display device having a narrow viewing angle is described in Patent Literature 3. On this account, it is preferable that a display device is capable of freely changing a viewing angle, so as to have different viewing angles in accordance with how the display device is used.

Each of Patent Literatures 4 through 6 describes a display device capable of changing a viewing angle. Patent Literature 4 describes a liquid crystal display device in which a light scattering liquid crystal layer for controlling scattering and transmission of light in response to an applied voltage is provided behind a liquid crystal display panel. The liquid crystal display device of Patent Literature 4 decreases or increases a viewing angle by controlling incidence of light to the liquid crystal display panel in response to a voltage applied to the light scattering liquid crystal layer.

Patent Literature 5 describes a liquid crystal display device in which a viewing angle controlling panel is provided behind a display liquid crystal panel. The viewing angle controlling panel includes two control panel polarizing plates, two phase plates, and a liquid crystal cell sandwiched by the two control panel polarizing plates and the two phase plates. The liquid crystal display device of Patent Literature 5 is configured to shield light omnidirectionally so as to narrow a viewing angle by changing the viewing angle, and by setting a retardation value of the phase plates to a predetermined value, the viewing angle being changed by switching the liquid crystal cell of the viewing angle controlling panel.

Patent Literature 6 describes a display device having a front surface on which a first optical element and a second optical element are provided. The first optical element has a convex lens for refracting light from the display device. The second optical element has a concave lens for substantially canceling a refractive index of the convex lens. According to the display device of Patent Literature 6, a viewing angle is changed by change in relative location of the first optical element and the second optical element.

### CITATION LIST

### Patent Literature

Patent Literature 1

Japanese Patent Application Publication Tokukai No. 2000-352608 A (Publication Date: Dec. 19, 2000)

Patent Literature 2

Japanese Patent Application Publication Tokukai No. 2003-50307 A (Publication Date: Feb. 21, 2003)

Patent Literature 3

Japanese Patent Application Publication Tokukai No. 2005-338270 A (Publication Date: Dec. 8, 2005)

Patent Literature 4

Japanese Patent Application Publication Tokukaihei No. 10-319384 A (Publication Date: Dec. 4, 1998)

Patent Literature 5

Japanese Patent Application Publication Tokukai No. 2008-310271 A (Publication Date: Dec. 25, 2008)

Patent Literature 6

Japanese Patent Application Publication Tokukai No. 2003-288025 A (Publication Date: Oct. 10, 2003)

### SUMMARY OF INVENTION

### Technical Problem

However, the display device described in each of Patent Literatures 4 and 5 requires a liquid crystal panel for changing a viewing angle, other than a display liquid crystal panel. This causes a decrease in luminance, and an increase in thickness of the display device. The display device of Patent Literature 6 requires two optical elements to be provided on its whole display surface. This causes an increase in thickness of the display device. Further, the display device of Patent Literature 6 differs in its thickness from when having a narrow viewing angle to when having a wide viewing angle.

The present invention was made in view of the problem, and an object of the present invention is to produce a display device capable of changing a viewing angle with no increase in thickness of the display device.

### Solution to Problem

In order to attain the object, a light diffusion sheet of the present invention, including: a high refractive material layer having a light entering surface and a light emitting surface, the high refractive material layer including: wide viewing regions each including first low refractive parts, each of which has (i) a shape which projects from the light emitting surface toward the light entering surface and (ii) a refractive index lower than that of the high refractive material layer; and narrow viewing regions each including second low refractive parts, each of which has (i) a shape which projects from the light entering surface toward the light emitting surface and (ii) a refractive index lower than that of the high refractive material layer.

A display panel of the present invention includes the light diffusion sheet. A display device of the present invention includes the display panel, and a driving control section for controlling driving of the pixels, the driving control section controlling switching between (i) driving of pixels which causes light to enter the respective wide viewing regions and (ii) driving of pixels which causes light to enter the respective narrow viewing regions.

According to the configuration, the light diffusion sheet includes the wide viewing regions and the narrow viewing regions. It is therefore possible to carry out wide viewing display by incidence of light to the wide viewing regions, and to carry out narrow viewing display by incidence of light to the narrow viewing regions. The driving control section of the display device including the display panel to which the light diffusion sheet is attached controls the switching between (i) the driving of the pixels which causes light to enter the respective wide viewing regions and (ii) the driving of the pixels which causes light to enter the respective narrow viewing regions. Such switching between the drivings (i) and (ii) above allows switching between the wide viewing display carried out in the wide viewing regions and the narrow viewing display carried out in the narrow viewing displays. This ultimately allows a change in viewing angle.

It is therefore unnecessary to newly provide a configuration for changing a viewing angle, such as a liquid crystal layer for changing a viewing angle. The viewing angle can thus be changed with no increase in thickness of the display device.

### Advantageous Effects of Invention

A light diffusion sheet of the present invention, including: a high refractive material layer having a light entering surface and a light emitting surface, the high refractive material layer including: wide viewing regions each including first low refractive parts, each of which has (i) a shape which projects from the light emitting surface toward the light entering surface and (ii) a refractive index lower than that of the high refractive material layer; and narrow viewing regions each including second low refractive parts, each of which has (i) a shape which projects from the light entering surface toward the light emitting surface and (ii) a refractive index lower than that of the high refractive material layer. This makes it possible to change a viewing angle without increase in thickness of an apparatus.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is an exploded perspective view illustrating (i) a light diffusion sheet in accordance with an embodiment of the present invention and (ii) a liquid crystal panel to which the light diffusion sheet is attached.

FIG. 2

(a) and (b) of FIG. 2 each are a perspective view illustrating a partially enlarged part of a light diffusion sheet in accordance with an embodiment of the present invention.

FIG. 3

(a) and (b) of FIG. 3 each are a cross-sectional view illustrating a partially enlarged part of a light diffusion sheet in accordance with an embodiment of the present invention.

FIG. 4

FIG. 4 is a view schematically illustrating how a light diffusion sheet in accordance with an embodiment of the present invention changes a viewing angle.

FIG. 5

FIG. 5 is an exploded perspective view illustrating (i) a light diffusion sheet in accordance with an embodiment of the present invention and (ii) wide viewing display of a liquid crystal panel to which the light diffusion sheet is attached.

FIG. 6

FIG. 6 is an exploded perspective view illustrating (i) a light diffusion sheet in accordance with an embodiment of the present invention and (ii) narrow viewing display of a liquid crystal panel to which the light diffusion sheet is attached.

FIG. 7

FIG. 7 is an exploded perspective view illustrating (i) a light diffusion sheet in accordance with another embodiment of the present invention and (ii) wide viewing display of a liquid crystal panel to which the light diffusion sheet is attached.

FIG. 8

FIG. 8 is an exploded perspective view illustrating (i) a light diffusion sheet in accordance with another embodiment of the present invention and (ii) narrow viewing display of a liquid crystal panel to which the light diffusion sheet is attached.

FIG. 9

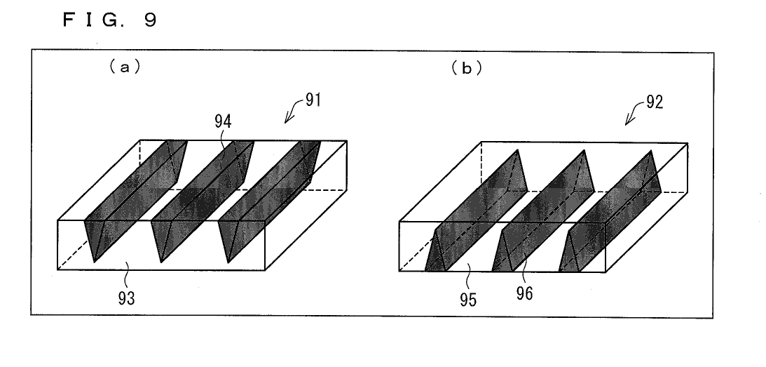

(a) and (b) of FIG. 9 each are a perspective view illustrating a partially enlarged part of a light diffusion sheet in accordance with another embodiment of the present invention.

### DESCRIPTION OF EMBODIMENTS

### Embodiment 1

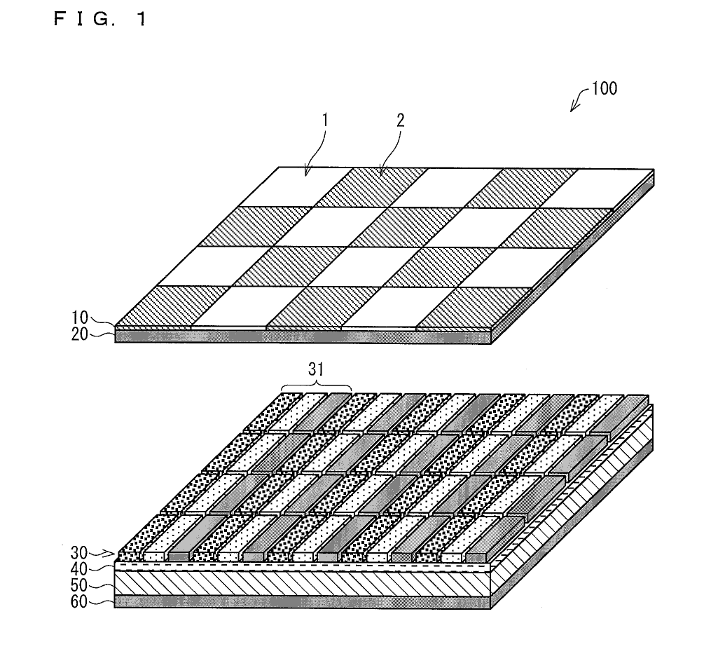

The following description will discuss a light diffusion sheet 10 in accordance with an embodiment of the present invention, with reference to FIGS. 1 through 6. Embodiment 1 exemplifies a case where the light diffusion sheet 10 is used in a liquid crystal display device. Note, however, that the light diffusion sheet 10 of Embodiment 1 is not limited to the case. The light diffusion sheet 10 can therefore be used in other display devices, such as an organic EL display device and a PDP display device, each of which employs light emitted from the display device itself. FIG. 1 is an exploded perspective view illustrating a liquid crystal panel (display panel) 100 including the light diffusion sheet 10. Specifically, the light diffusion sheet 10 (i) is attached onto an outer polarizing plate 20 of the liquid crystal panel 100 and (ii) has wide viewing regions 1 and narrow viewing regions 2.

The liquid crystal panel 100 has a configuration in which the outer polarizing plate 20 is attached onto a CF side substrate 30. The liquid crystal panel 100 further includes a liquid crystal layer 40, a TFT side substrate 50, and an inner polarizing plate 60, in this order, beneath the CF side substrate 30. The CF side substrate 30 has a surface, facing the liquid crystal layer 40, onto which a color filter is attached. According to the color filter, colored layers by which red (R) light, green (G) light, and blue (B) light are transmitted are arranged so as to correspond to respective liquid crystal pixels (pixels). RGBs 31 of the color filter correspond to the respective liquid crystal pixels. A backlight is provided behind the inner polarizing plate 60 so as to irradiate the inner polarizing plate 60 with light.

The light diffusion sheet 10 diffuses or transmits, by use of a difference in refractive index, light that has entered the light diffusion sheet 10 from the outer polarizing plate 20, so as to emit the light causing a range of viewing field to be wide or narrow, respectively. Each of the wide viewing regions 1 and the narrow viewing regions 2 of the light diffusion sheet 10 is provided for a corresponding liquid crystal pixel, that is, a corresponding RGB 31. The wide viewing regions 1 and the narrow viewing regions 2 are arranged alternately and adjacent to each other so as to form a checkered pattern.

Each of the outer polarizing plate 20 and the inner polarizing plate 60 transmits only light waves that oscillate in a corresponding constant direction. Conventionally well-known polarizing plates can be used as each of the outer polarizing plate 20 and the inner polarizing plate 60. A glass substrate is suitably applicable to each of the CF side substrate 30 and the TFT side substrate 50. Among them, the CF side substrate 30 is preferably reduced in thickness so as to have a thickness of, for example, approximately 200 μm by being subjected to chemical etching, etc. Such a reduction in thickness of the CF side substrate 30 causes a distance to be shortened between the respective liquid crystal pixels and the light diffusion sheet 10. This makes it possible to improve directivity of light that enters each of the wide viewing regions 1 or each of the narrow viewing regions 2 of the light diffusion sheet 10.

The liquid crystal layer 40 includes liquid crystal. The liquid crystal is sandwiched between two alignment films. The two alignment films are sandwiched between two transparent electrodes. The liquid crystal is driven by a voltage applied across the transparent electrodes so as to align in a certain direction along the alignment films. This causes light transmittance to be controlled. The members, including the light diffusion sheet 10, of the liquid crystal panel 100 can be layered and combined with each other by a conventionally well-known method.

The following description will discuss in detail the configuration of the light diffusion sheet 10, with reference to

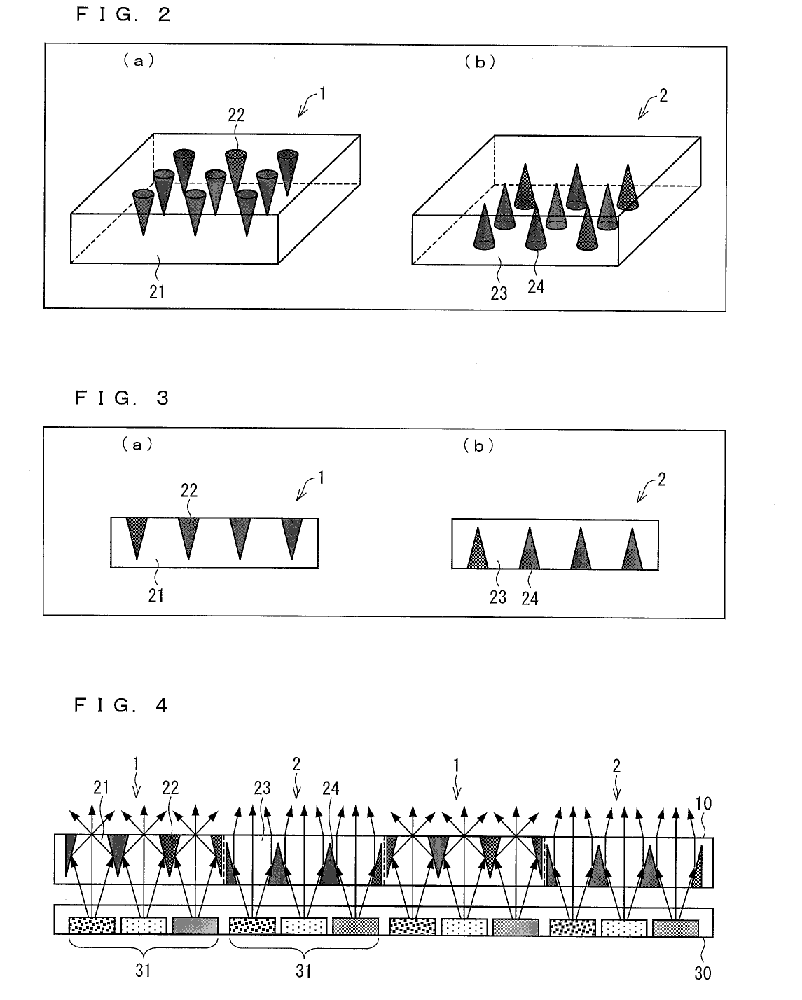

FIGS. 2 and 3. (a) and (b) of FIG. 2 each are a perspective view illustrating a partially enlarged part of a light diffusion sheet in accordance with an embodiment of the present invention. (a) and (b) of FIG. 3 each are a cross-sectional view illustrating a partially enlarged part of a light diffusion sheet in accordance with an embodiment of the present invention. Each of (a) of FIG. 2 and (a) of FIG. 3 illustrates a wide viewing region 1. Each of (b) of FIG. 2 and (b) of FIG. 3 illustrates a narrow viewing region 2.

As illustrated in (a) of FIG. 2 and (a) of FIG. 3, the wide viewing region 1 is constituted by a high refractive part (high refractive material layer) 21 and low refractive parts (first low refractive parts) 22. Note that how to form each of the low refractive parts 22 is not particularly limited, provided that it is formed so as to have a shape which projects from a light emitting surface of the wide viewing region 1 toward a light entering surface of the wide viewing region 1 (toward the backlight). As illustrated in (a) of FIG. 3, the low refractive part 22 preferably has a substantially V-shaped cross section that tapers off toward the light entering surface, when the low refractive part 22 is cut off by a plane perpendicular to the light emitting surface and the light entering surface. Therefore, the low refractive part 22 can have, for example, a cone shape that tapers off toward the light entering surface (see (a) of FIG. 2). Alternatively, the low refractive part 22 can have a pyramid shape such as a triangular pyramid.

A material of the high refractive part 21 is not limited to a specific one, provided that the high refractive part 21 is made from a material having a refractive index higher than that of the low refractive part 22. It is preferable that the high refractive part 21 be made from, for example, a transparent resin that is high in transmittance. Examples of a high refractive material for the high refractive part 21 encompass epoxy acrylate, and transparent resins such as vinyl chloride resins, styrene resins, polyurethane resins, polyester resins, acrylic resins, and polycarbonate resins. However, the material for the high refractive part 21 is not limited to the examples.

The low refractive part 22 is not limited to have a specific configuration, provided that it has a refractive index lower than that of the high refractive part 21. Therefore, the low refractive part 22 can be made from a low refractive material. Alternatively, the low refractive part 22 can be a groove that is provided in the high refractive part 21 so that the groove is hollow on the light entering surface side. Such a groove can be further filled with air. Examples of the low refractive material for the low refractive part 22 encompass (i) acrylic resins, (ii) epoxy resins, (iii) polycarbonate resins, (iv) polyester resins, and (v) acrylate resins into which an element such as silicon or fluorine has been introduced. However, the low refractive material for the low refractive part 22 is not limited to the examples.

In the wide viewing region 1, an interface between the high refractive part 21 and the low refractive part 22 is configured so that light incident on the interface (i) is subjected to total reflection or (ii) is transmitted by the interface. That is, an angle between the interface and the light emitting surface is set so as to allow incident light to be sufficiently diffused. Light that (i) has entered the low refractive part 22 without having been subjected to total reflection at the interface and (ii) is then emitted, becomes stray light which causes image blur. It is therefore preferable that the low refractive part 22 be configured to absorb light that has entered the low refractive part 22 so as not to emit the light. It is preferable that the low refractive part 22 be thus configured to have (a) a refractive index lower than that of the high refractive part 21 and (b) at least a part made from a material for absorbing the light that has entered the low refractive part 22. A black material having a high OD value can be suitably employed as the material for absorbing the light that has entered the low refractive part 22.

As illustrated in (b) of FIG. 2 and (b) of FIG. 3, the narrow viewing region 2 is constituted by a high refractive part (high refractive material layer) 23 and low refractive parts (second low refractive parts) 24. Note that how to form each of the low refractive parts 24 is not particularly limited, provided that it is formed so as to have a shape which projects from a light entering surface of the narrow viewing region 2 toward a light emitting surface of the narrow viewing region 2. As illustrated in (b) of FIG. 3, the low refractive part 24 preferably has a substantially V-shaped cross section that tapers off toward the light emitting surface, when the low refractive part 24 is cut off by a plane perpendicular to the light emitting surface and the light entering surface. Therefore, the low refractive part 24 can have, for example, a cone shape that tapers toward off the light emitting surface (see (b) of FIG. 2). Alternatively, the low refractive part 24 can have a pyramid shape such as a triangular pyramid.

In the narrow viewing 2, an interface between the high refractive part 23 and the low refractive part 24 is configured so that light incident on the interface (i) is subjected to total reflection or (ii) is transmitted by the interface. That is, an angle between the interface and the light emitting surface is set so as to allow incident light to be converged.

The light entering surface of the narrow viewing region 2 is the same as the light emitting surface of the wide viewing region 1. The light emitting surface of the narrow viewing region 2 is the same as the light entering surface of the wide viewing region 1. That is, the narrow viewing region 2 is the wide viewing region 1 that has been turned upside down. The high refractive part 23 of the narrow viewing region 2 is made from a material identical to that of the high refractive part 21 of the wide viewing region 1. The low refractive part 24 of the narrow viewing region 2 is made from a material identical to that of the narrow refractive part 22 of the wide viewing region 1. The low refractive part 24 of the narrow viewing region 2 preferably has at least a part filled with a material for absorbing light so that stray light is not caused, as with the low refractive part 22 of the wide viewing region 1.

In the light diffusion sheet 10, the high refractive part 21 of the wide viewing region 1 and the high refractive part 23 of the narrow viewing region 2 constitute a single high refractive material layer. The wide viewing region 1 has no low refractive part 24. The narrow viewing region 2 has no low refractive part 22.

There is no particular limitation on, for example, each of (i) a ratio of the high refractive part 21 (the high refractive part 23) to the low refractive part 22 (the low refractive part 24) in the wide viewing region 1 (the narrow viewing region 2), (ii) intervals at which the low refractive part 22 is arranged, (iii) intervals at which the low refractive part 24 is arranged, (iv) how the low refractive part 22 is arranged, and (v) how the low refractive part 24 is arranged, provided that they are determined as appropriate so as to bring about a desired effect. The low refractive parts 22 and 24, each having a conical shape, can be arranged regularly or at random.

The light diffusion sheet 10 can be manufactured by a conventionally well-known method such as that described in Patent Literatures 1 through 3. For example, a high refractive material is subjected to, for example, press molding or injection molding by use of a mold matching a shape of low refractive parts 22 so that wide viewing regions 1 are arranged, for respective pixels, in a checkered manner. The high refractive material in which the wide viewing regions 1 are formed is turned upside down. Parts of the high refractive material of the light diffusion sheet 10, in each of which parts no wide viewing region 1 is formed, is subjected to, for example, press molding or injection molding by use of a mold matching a shape of low refractive parts 24 so that (i) narrow viewing regions 2 for respective pixels and (ii) the wide viewing regions 1 are alternately arranged. The high refractive material is then cured, so that the light diffusion sheet 10 is manufactured.

The following description will discuss how the light diffusion sheet 10 changes a viewing angle, with reference to FIG. 4. FIG. 4 is a view schematically illustrating how the light diffusion sheet 10 in accordance with an embodiment of the present invention changes a viewing angle. As illustrated in FIG. 4, the wide viewing regions 1 and the narrow viewing regions 2 are alternately arranged in the light diffusion sheet 10 such that each set of RGBs 31 of the color filter, attached to the CF side substrate 30, face a corresponding one of the wide viewing regions 1 and the narrow viewing regions 2.

Light emitted from a backlight enters, via the CF side substrate 30, each of the wide viewing regions 1. The light is (i) transmitted by the high refractive part 21 of the wide viewing region 1, (ii) subjected to total reflection by the low refractive parts 22, and (iii) then diffused. In the wide viewing region 1, each of the low refractive parts 22 is formed so as to have a shape which projects from the light emitting surface toward the CF side substrate 30. This causes the light, subjected to total reflection by the low refractive part 22, to be diffused and then emitted as emission light that causes a range of viewing field to be wide.

Light emitted from the backlight enters, via the CF side substrate 30, each of the narrow viewing regions 2. The light is transmitted by the high refractive part 23 of the narrow viewing region 2, and is then subjected to total reflection by the low refractive parts 24. In the narrow viewing region 2, each of the low refractive parts 24 is formed so as to have a shape which projects from the CF side substrate 30 toward the light emitting surface. This causes the light, subjected to total reflection by the low refractive part 24, to be converged and then emitted as emission light that causes a range of viewing field to be narrow.

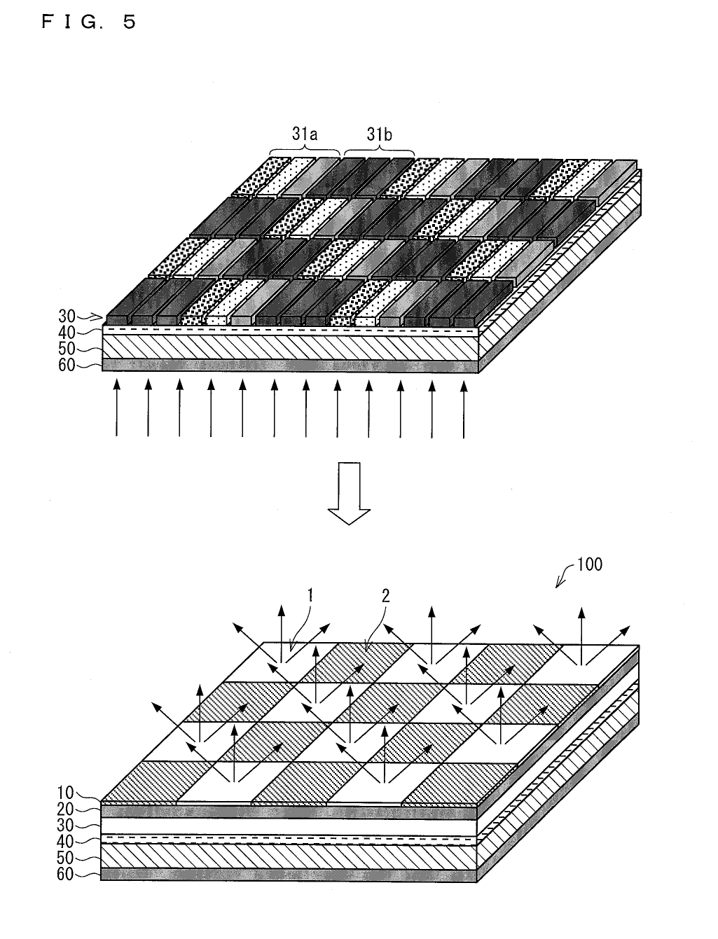

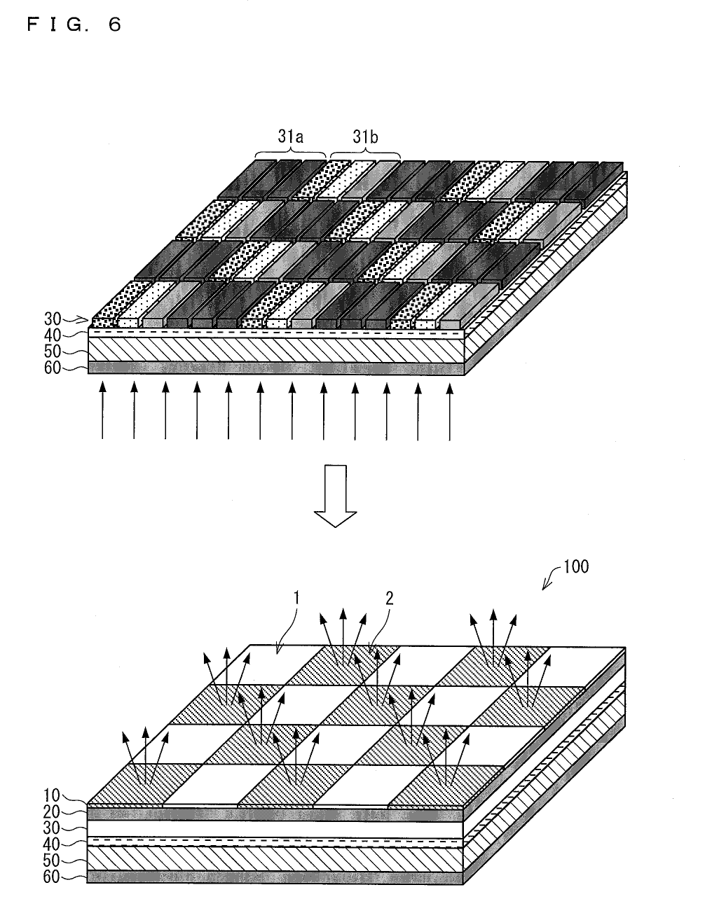

The following description will discuss wide viewing display and narrow viewing display of a liquid crystal panel 100 in which the light diffusion sheet 10 is attached, with reference to FIGS. 5 and 6. FIG. 5 is an exploded perspective view illustrating (i) a light diffusion sheet 10 and (ii) wide viewing display of a liquid crystal panel 100 to which the light diffusion sheet 10 is attached. FIG. 6 is an exploded perspective view illustrating (a) a light diffusion sheet 10 and (b) narrow viewing display of a liquid crystal panel 100 to which the light diffusion sheet 10 is attached. Each of upper parts of FIGS. 5 and 6 illustrates, for convenience, the liquid crystal panel 100 from which the light diffusion sheet 10 and an outer polarizing plate 20 are removed.

During the wide viewing display, first liquid crystal pixels for respective RGBs 31a, which correspond to respective wide viewing regions 1 arranged in a checkered manner, are merely driven. This causes light to be emitted merely from the wide viewing regions 1 (see a lower part of FIG. 5). The light to be emitted from the wide viewing regions 1 is diffused in the wide viewing regions 1. This causes a range of viewing field to be wide. The liquid crystal display panel 100 can thus carry out the wide viewing display.

During the narrow viewing display, second liquid crystal pixels for respective RGBs 31b, which correspond to respective narrow viewing regions 2 arranged in a checkered manner, are driven. This causes light to be emitted merely from the narrow viewing regions 2 (see a lower part of FIG. 6). The light to be emitted from the narrow viewing regions 2 is converged in the narrow viewing regions 2. This causes a range of viewing field to be narrow. The liquid crystal display panel 100 can thus carry out the narrow viewing display.

Switching is carried out between (i) driving of the first liquid crystal pixels and (ii) driving of the second liquid crystal pixels so as to carry out partial driving, i.e., so as to merely drive the first liquid pixels or the second liquid pixels. Such switching between the drivings (i) and (ii) above allows switching between the wide viewing display and the narrow viewing display. This ultimately allows a change in viewing angle. Each of the wide viewing regions 1 and the narrow viewing regions 2 is provided for a corresponding one of the liquid crystal pixels, i.e., the first and second liquid crystal pixels. It is therefore possible to easily change a viewing angle just by switching between the driving of the first liquid crystal pixels and the driving of the second liquid crystal pixels.

Note that a viewing angle can be changed by partially driving the liquid crystal pixels, even in a case where (i) the wide viewing regions 1 and the narrow viewing regions 2 and (ii) the liquid crystal pixels do not have a complete one-one relation. Furthermore, it is possible to carry out normal display, by driving all of the liquid crystal pixels so as to improve brightness.

The driving of the liquid crystal pixels can be switched by a driving control device (driving control section) (not shown) which switches between the driving of the first liquid crystal pixels and the driving of the second liquid crystal pixels.

A display device, including the liquid crystal panel 100 to which the light diffusion sheet 10 is attached, can employ a conventionally well-known backlight as a light source provided behind the liquid crystal panel 100. For example, a directional backlight with an optical sheet having an inverted prism shape is preferably employed as the light source. Such a directional backlight is provided behind a surface of the liquid crystal panel 100, which surface is opposite to a surface where the light diffusion sheet 10 is provided. The directional backlight irradiates the liquid crystal panel 100 with light, which has a parallel directivity and enters the liquid crystal panel 100 substantially perpendicularly to the liquid crystal panel 100. This causes an improvement in directivity of each light that enters the wide viewing regions 1 and the narrow viewing regions 2 of the light diffusion sheet 10. As such, it is possible to control the viewing angle with more accuracy.

It is thus possible for the liquid crystal display panel 100 including the light diffusion sheet 10 to provide a liquid crystal display device whose viewing angle is variable. For example, in a case where a user desires, from the viewpoint of confidentiality, a narrow range of viewing field like a display of a mobile phone, etc., light having a narrow viewing angle is emitted from the light diffusion sheet 10. On the contrary, light having a wide viewing angle is emitted from the light diffusion sheet 10, in a case where the user desires a wide range of viewing field, such as a case where a display is viewed from all directions.

### Embodiment 2

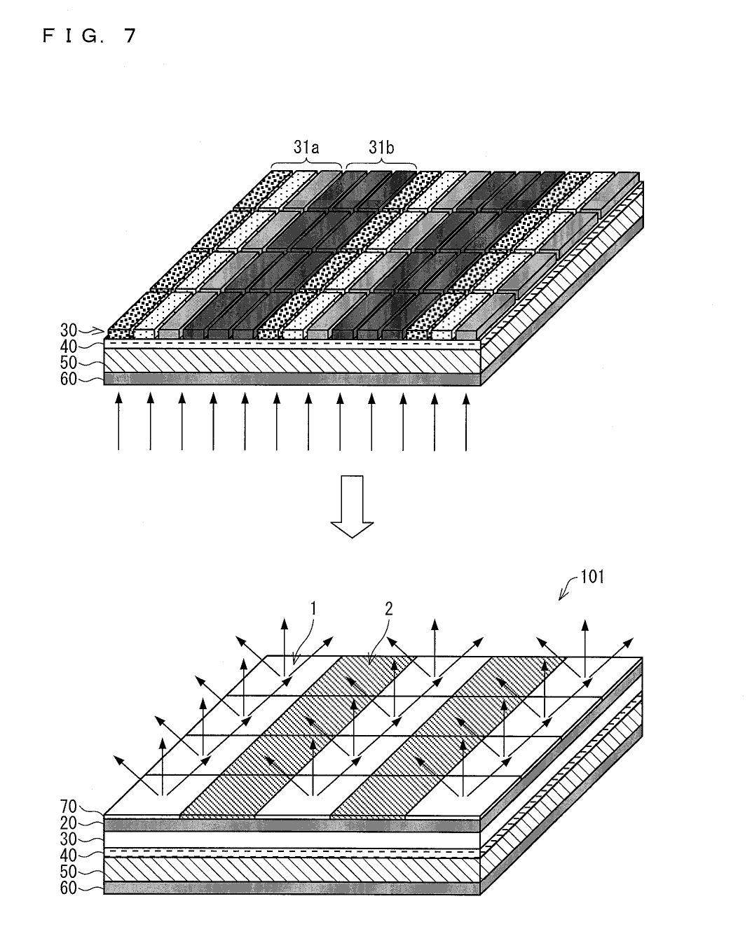

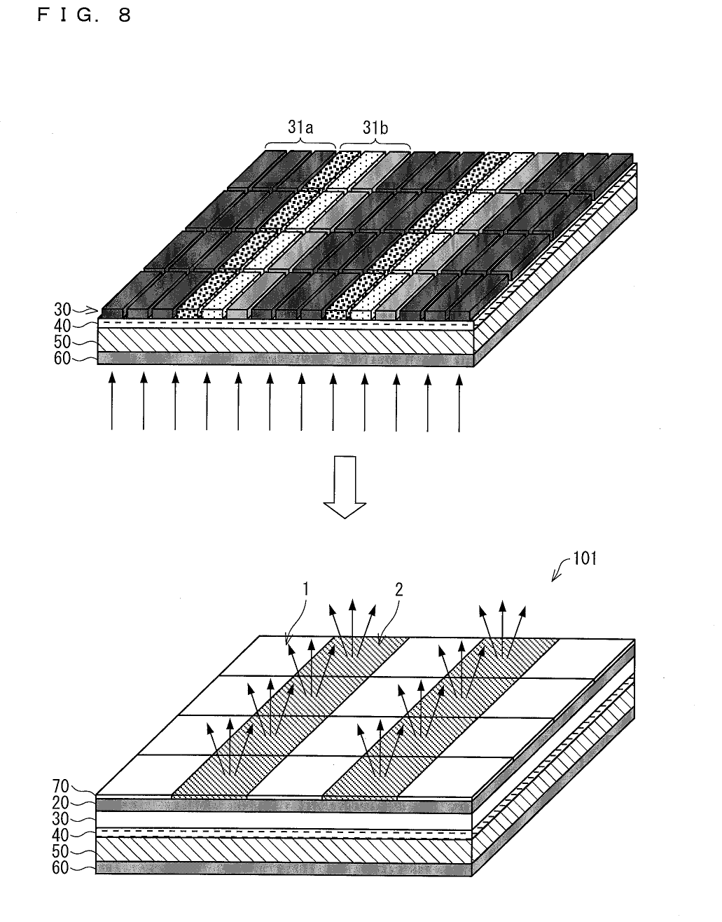

The following description will discuss a light diffusion sheet 70 in accordance with Embodiment 2 of the present invention, with reference to FIGS. 7 and 8. Embodiment 2 exemplifies a case where the light diffusion sheet 70 is employed in a liquid crystal display device. However, the light diffusion sheet 70 of Embodiment 2 is not limited to the case. The light diffusion sheet 70 can be used in other display devices, such as an organic EL display device and a PDP display device, each of which employs light emitted from the display device itself. FIG. 7 is an exploded perspective view illustrating (i) a light diffusion sheet in accordance with Embodiment 2 of the present invention and (ii) wide viewing display of a liquid crystal panel to which the light diffusion sheet is attached. FIG. 8 is an exploded perspective view illustrating (a) a light diffusion sheet in accordance with Embodiment 2 of the present invention and (ii) narrow viewing display of a liquid crystal panel to which the light diffusion sheet is attached. Each of upper parts of FIGS. 7 and 8 illustrates, for convenience, a liquid crystal panel (display panel) 101 from which the light diffusion sheet 70 and an outer polarizing plate 20 are removed.

As illustrated in FIGS. 7 and 8, each of wide viewing regions 1 and narrow viewing regions 2 of the light diffusion sheet 70 is provided for a corresponding one of liquid crystal pixels. The wide viewing regions 1 are provided linearly so as to intersect with a direction in which light travels, and the narrow viewing regions 2 are also linearly provided so as to intersect with the direction in which the light travels. The wide viewing regions 1 linearly provided and the narrow viewing regions 2 linearly provided are alternately arranged so as to form a stripe pattern. The wide viewing regions 1 and the narrow viewing regions 2 of the light diffusion sheet 70 in accordance with Embodiment 2 are configured similarly to those of the light diffusion sheet 10 of Embodiment 1, except that the wide viewing regions 1 and the narrow viewing regions 2 of Embodiment 2 are arranged in a stripe manner.

The liquid crystal panel 101 includes the light diffusion sheet 70, an outer polarizing plate 20, a CF side substrate 30, a liquid crystal layer 40, a TFT side substrate 50, and an inner polarizing plate 60, in this order, beneath a light emitting surface of the liquid crystal panel 101. That is, the liquid crystal panel 101 is different from the liquid crystal panel 100 of Embodiment 1 merely in that the arrangement of the wide viewing regions 1 and the narrow viewing regions 2 of the light diffusion sheet 70 is different from those of the light diffusion sheet 10. Embodiment 2 will describe merely matters different from those of Embodiment 1, and therefore descriptions of other details are omitted.

During wide viewing display, first liquid crystal pixels for respective RGBs 31a, which correspond to the respective wide viewing regions 1 linearly provided, are driven. This causes light to be emitted merely from the wide viewing regions 1 (see a lower part of FIG. 7). The light to be emitted from the wide viewing regions 1 is diffused in the wide viewing regions 1. This causes a range of viewing field to be wide. The liquid crystal panel 101 can thus carry out the wide viewing display.

During narrow viewing display, second liquid crystal pixels for respective RGBs 31b, which correspond to the respective narrow viewing regions 2 linearly provided are driven. This causes light to be emitted merely from the narrow viewing regions 2 (see a lower part of FIG. 8). The light to be emitted from the narrow viewing regions 2 is converged in the narrow viewing regions 2. This causes a range of viewing field to be narrow. The liquid crystal panel 101 can thus carry out the narrow viewing display.

Switching is carries out between (i) driving of the first liquid crystal pixels and (ii) driving of the second liquid crystal pixels so as to carry out partial driving, i.e., so as to merely drive the first liquid pixels or the second liquid pixels. Such switching between the drivings (i) and (ii) above allows switching between the wide viewing display and the narrow viewing display. This ultimately allows a change in viewing angle.

Each of the wide viewing regions of Embodiment 2 can be alternatively configured as illustrated in (a) of FIG. 9. Each of the narrow viewing regions of Embodiment 2 can be alternatively configured as illustrated in (b) of FIG. 9. Each of (a) and (b) of FIG. 9 is a perspective view illustrating a partially enlarged part of a light diffusion sheet in accordance with another embodiment of the present invention. (a) of FIG. 9 illustrates a wide viewing region 91. (b) of FIG. 9 illustrates a narrow viewing region 92.

As illustrated in (a) of FIG. 9, the wide viewing region 91 has a high refractive part (high refractive material layer) 93 and low refractive parts (first low refractive parts) 94. Each of the low refractive parts 94 is a groove, provided in line, which is hollow from a light emitting surface of the wide viewing region 91 toward a light entering surface of the wide viewing region 91 (toward a backlight). The lower refractive part 94 has a substantially V-shaped cross section that tapers off toward the light entering surface, when the lower refractive part 94 is cut off by a plane perpendicular to (i) the light emitting surface and the light entering surface and (ii) a direction in which the groove extends. The high refractive part 93 and the low refractive part 94 are identical to the high refractive part 21 and the low refractive part 22 in, for example, how to form, materials, and an angle made by an interface.

As illustrated in (b) of FIG. 9, the narrow viewing region 92 has a high refractive part (high refractive material layer) 95 and low refractive parts (second low refractive parts) 96. Each of the low refractive parts 96 is a groove, provided in line, which is hollow from a light entering surface of the narrow viewing region 92 toward a light emitting surface of the narrow viewing region 92. The lower refractive part 96 has a substantially V-shaped cross section that tapers off toward the light emitting surface, when the lower refractive part 96 is cut off by a plane perpendicular to (i) the light emitting surface and the light entering surface and (ii) a direction in which the groove extends. The high refractive part 95 and the low refractive part 96 are identical to the high refractive part 23 and the low refractive part 24 in, for example, how to form, materials, and an angle made by an interface.

It is possible to switch merely a viewing angle in a direction intersecting with the low refractive parts 94 and 96, by employing a light diffusion sheet in which the low refractive part 94 of the wide viewing region 91 is arranged parallel to the low refractive part 96 of the narrow viewing region 92. Note that the wide viewing regions 91 and the narrow viewing regions 92 can be alternately arranged so as to form a checkered pattern, as with the light diffusion sheet 10 of Embodiment 1. Alternatively, linearly provided wide viewing regions 91 and linearly provided narrow viewing regions 92 can be alternately arranged so as to form a stripe pattern, as with the light diffusion sheet 70 of Embodiment 2.

[Additional Description]

It is preferable to configure the light diffusion sheet of the present invention such that each of the wide viewing regions is arranged adjacent to at least one of the narrow viewing regions and each of the narrow viewing regions is arranged adjacent to at least one of the wide viewing regions. It is further preferable to configure the light diffusion sheet of the present invention such that the wide viewing regions and the narrow viewing regions are arranged alternately and adjacent to each other so as to form a checkered pattern. It is further preferable to configure the light diffusion sheet of the present invention such that ones of the wide viewing regions linearly arranged and ones of the narrow viewing regions linearly arranged are arranged alternately and adjacent to each other so as to form a stripe pattern. With each of the configurations, a user is unlikely to perceive the lack of pixels during wide viewing display or narrow viewing display. It is therefore possible to change a viewing angle without extreme decrease in visibility.

It is preferable to configure the light diffusion sheet of the present invention such that each of the first low refractive parts has a substantially V-shaped cross section that tapers off toward the light entering surface, when the each of the first low refractive parts is cut off by a plane perpendicular to the light emitting surface and the light entering surface, and each of the second low refractive parts has a substantially V-shaped cross section that tapers off toward the light emitting surface, when the each of the second low refractive parts is cut off by a plane perpendicular to the light emitting surface and the light entering surface. It is further preferable to configure the light diffusion sheet of the present invention such that the first low refractive parts each have a conical or pyramid shape that tapers off toward the light entering surface, and the second low refractive parts each have a conical or pyramid shape that tapers off toward the light emitting surface. This allows the light diffusion sheet to efficiently diffuse and converge light.

It is preferable to configure a display panel of the present invention such that each of the wide viewing regions and the narrow viewing regions is provided for a corresponding one of pixels of the display panel in the light diffusion sheet.

According to the configuration, switching is carried out between (i) driving of the pixels corresponding to the respective wide viewing regions and (ii) driving of the pixels corresponding to the respective narrow viewing regions so as to carry out partial driving. Such switching between the drivings (i) and (ii) above allows switching between wide viewing display and narrow viewing display. This ultimately allows a change in viewing angle. Each of the wide viewing regions and the narrow viewing regions is provided for the corresponding one of pixels of the display panel in the light diffusion sheet. It is therefore possible to easily change a viewing angle just by switching between the driving of the pixels corresponding to the respective wide viewing regions and the driving of the pixels corresponding to the respective narrow viewing regions.

It is preferable that a display device of the present invention further include a directional backlight for irradiating the display panel with directional light, the directional backlight being provided behind a surface of the display panel, which surface is opposite to a surface where the light diffusion sheet is provided.

According to the configuration, the directional backlight is provided behind the surface of the display panel, which surface is opposite to the surface where the light diffusion sheet is provided. The directional backlight irradiates the display panel with, for example, light, which has a parallel directivity and enters the display panel substantially perpendicularly to the display panel. This causes an improvement in directivity of each light that enters the wide viewing regions and the narrow viewing regions of the light diffusion sheet. As such, it is possible to control the viewing angle with more accuracy.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to various display devices such as a TV, a PC and a mobile phone.

### REFERENCE SIGNS LIST

1: wide viewing region
2: narrow viewing region
10: light diffusion sheet
20: outer polarizing plate
21: high refractive part (high refractive material layer)
22: low refractive part (first low refractive part)
23: high refractive part (high refractive material layer)
24: low refractive part (second low refractive part)
30: CF side substrate
40: liquid crystal layer
50: TFT side substrate
60: inner polarizing plate
70: light diffusion sheet
91: wide viewing region
92: narrow viewing region
93: high refractive part (high refractive material layer)
94: low refractive part (first low refractive part)
95: high refractive part (high refractive material layer)
96: low refractive part (second low refractive part)
100: liquid crystal panel (display panel)
101: liquid crystal panel (display panel)

1. A light diffusion sheet, comprising a high refractive material layer having a light entering surface and a light emitting surface,
the high refractive material layer including:
wide viewing regions each including first low refractive parts, each of which has (i) a shape which projects from the light emitting surface toward the light entering surface and (ii) a refractive index lower than that of the high refractive material layer; and
narrow viewing regions each including second low refractive parts, each of which has (i) a shape which projects from the light entering surface toward the light emitting surface and (ii) a refractive index lower than that of the high refractive material layer.

2. The light diffusion sheet as set forth in claim 1, wherein:
each of the wide viewing regions is arranged adjacent to at least one of the narrow viewing regions and each of the narrow viewing regions is arranged adjacent to at least one of the wide viewing regions.

3. The light diffusion sheet as set forth in claim 2, wherein:
the wide viewing regions and the narrow viewing regions are arranged alternately and adjacent to each other so as to form a checkered pattern.

4. The light diffusion sheet as set forth in claim 2, wherein:
ones of the wide viewing regions linearly arranged and ones of the narrow viewing regions linearly arranged are arranged alternately and adjacent to each other so as to form a stripe pattern.

5. The light diffusion sheet as set forth in claim 1, wherein:
each of the first low refractive parts has a substantially V-shaped cross section that tapers off toward the light entering surface, when the each of the first low refractive parts is cut off by a plane perpendicular to the light emitting surface and the light entering surface, and
each of the second low refractive parts has a substantially V-shaped cross section that tapers off toward the light emitting surface, when the each of the second low refractive parts is cut off by a plane perpendicular to the light emitting surface and the light entering surface.

6. The light diffusion sheet as set forth in claim 5, wherein:
the first low refractive parts each have a conical or pyramid shape that tapers off toward the light entering surface, and
the second low refractive parts each have a conical or pyramid shape that tapers off toward the light emitting surface.

7. A display panel, comprising a light diffusion sheet recited in claim 1.

8. The display device as set forth in claim 7, wherein:
each of the wide viewing regions and the narrow viewing regions is provided for a corresponding one of pixels of the display panel in the light diffusion sheet.

9. A display device, comprising:
a display panel recited in claim 7; and
a driving control section for controlling driving of the pixels,
the driving control section controlling switching between (i) driving of pixels which causes light to enter the respective wide viewing regions and (ii) driving of pixels which causes light to enter the respective narrow viewing regions.

10. The display device as set forth in claim 9, further comprising:
a directional backlight for irradiating the display panel with directional light, the directional backlight being provided behind a surface of the display panel, which surface is opposite to a surface where the light diffusion sheet is provided.
